(19) United States
(12) Patent Application Publication
(10) Pub. No.: US 2026/0168548 A1
(43) Pub. Date: Jun. 18, 2026

(54) SPRING FOR A BRAKE PAD ASSEMBLY OF A BRAKING DEVICE

(71) Applicant: ZF Aftermarket Iberica, S.L, Corella (ES)

(72) Inventors: Konstantin VIKULOV, Corella (ES); Julen ORRANTIA SABORIT, Corella (ES)

(73) Assignee: ZF Aftermarket Iberica, S.L, Corella (ES)

(21) Appl. No.: 19/126,945

(22) PCT Filed: Nov. 3, 2023
(86) PCT No.: PCT/EP2023/080622

§ 371 Date: May 2, 2025

(30) Foreign Application Priority Data
Nov. 4, 2022 (EP) 22383061.3

(51) Int. Cl. F16D 65/097; F16D 65/00

(52) U.S. Cl. CPC F16D 65/0978; F16D 65/0006; F16D 2200/0021

(57) ABSTRACT

A spring for a brake pad assembly is configured to be pushed onto an interlocking element of a brake pad carrier plate. The spring has a clamp for securing the spring onto the interlocking element and a support member for supporting and sliding on a brake caliper. The support member has a first leg with a concave shape and configured to face toward the brake caliper. When the carrier plate and the spring are installed inside the brake caliper, the first leg forms a connecting section between a second leg and a third leg each configured to contact the brake caliper. Fourth, fifth, and sixth legs are configured face toward the brake pad carrier plate when installed. The spring also has a connecting leg that integrally connects the clamp to the support member. Also disclosed is brake pad assembly a braking device including such a spring.

### RELATED APPLICATIONS

This application claims the benefit under 35 U.S.C. § 371 as a U.S. National Phase Application of application no. PCT/EP2023/080622, filed on 3 Nov. 2023, which claims the benefit of European Patent Application no. EP22383061.3 filed on 4 Nov. 2022, the contents of which are hereby incorporated herein by reference in their entireties.

### FIELD OF THE DISCLOSURE

The present invention relates to a spring for a brake pad assembly or a braking device, in particular a disk brake, such that the spring is designed to be pushed onto an interlocking element of a brake pad carrier plate. The spring comprises a clamp for securing the spring onto the interlocking element and a support member for supporting and sliding on a brake caliper or a brake caliper housing. In this connection, a brake pad assembly and a braking device, in particular a disk brake, are also disclosed

### BACKGROUND

Disk brakes serve to slow down and stop a motor vehicle by friction force between a friction surface of a brake pad and a rotating component, i.e., a brake disk. The most common design of a disk brake comprises two brake pads, also called brake blocks, a brake disk, and a brake caliper, all of them installed in an assembly at an end of an axle of the motor vehicle. At the end of the axle concerned other additional chassis components, such as steering and wheel suspension components, can also be fitted. The two brake pads are arranged on the brake caliper, which covers the brake disk on both sides, i.e., on the inside and outside. The brake pads are fitted with a friction material surface that faces toward the brake disk, and is parallel to the brake disk surface so that the disk can rotate freely between the two blocks with no friction. The opposite side of each brake pad supports a metallic carrier plate or support plate which faces away from the friction material surface, i.e., outward. The brake disk is connected rotationally fixed to the wheel or a wheel hub of the motor vehicle so that the wheel and the brake disk rotate at the same rotation speed. When the brake is actuated, the brake pads are pressed against the brake disk, so that the friction force between each brake pad and the brake disk reduces the rotation speed of the disk and the wheel down to a complete standstill.

As a rule, the brake caliper has one or more pistons, which by virtue of a hydraulic circuit can move in a direction perpendicular to the surface of the carrier plate when pressure is exerted on a brake pedal of the motor vehicle. This piston movement is transmitted to the brake pads, which move toward the disk surface from both sides of the brake disk and thus clamp the brake disk firmly. The rotation movement of the brake disk produces a sliding friction force on the brake pad surface, which force is transmitted via the carrier plate to the brake caliper.

A common design of a carrier plate consists of a flat, laminated metal sheet with a thickness of 5 to 6 mm and a peripheral counter-form, which fits into the brake caliper and has features which are at their most effective when the braking force is transmitted. It is necessary for the carrier plate of a brake pad to have contact surfaces with the brake caliper. These contact surfaces are designed so that they can withstand the large mechanical forces produced when braking. In order to reduce braking noises, typically “rattling” produced by the movement of the brake pad in the brake caliper, and preferably to avoid such noises altogether, clamps—also called clips—or elastic springs are attached on the contact surfaces of the brake pad with the brake caliper. Such clips can be used to control the movement of the brake pad within the brake caliper in any direction, typically in the tangential direction relative to the rotation direction of the brake disk and/or in the radial direction relative to the rotation direction of the brake disk.

As a rule, the clamps described in the prior art consist of laminated steel with curved shapes, such that the legs of the two surfaces to be separated face one another. The respective leg facing toward the carrier plate has a special shape in order to be connected to the carrier plate and to support it so that there is very little freedom for sliding relative to the carrier plate. The leg facing the brake caliper is designed to be curved and has a convex contact surface relative to the surface of the brake caliper. The result of such a design is that the forces are concentrated on a limited contact area.

EP 2 072850 A1 discloses examples of elastic clamps which are attached to the carrier plate in order to separate the underside of the projection of the brake pad from the underside of the brake caliper. When the elastic clamp or spring concerned is fitted in the brake caliper, direct contact is prevented between the lower side surfaces of the carrier plate and the upper surface of the brake caliper, thereby reducing the “rattling noises” when a braking force is applied in order to slow the vehicle down.

### SUMMARY

The purpose of the present invention is to propose a spring for a brake pad assembly, a brake pad assembly for a braking device and a braking device with improved NVH (“Noise, Vibrations and Harshness”) properties. This objective is achieved by a spring for a brake pad assembly and a brake pad assembly according to the present disclosure. Further advantageous embodiments will emerge from the present disclosure.

The basic concept of the present invention consists in changing the convex shape of the contact surface between the spring and the brake caliper to a flat or a concave shape Such design improves the stability of the contact surfaces and reduces the possibility of vibrations or rotation of the components. Consequently, the NVH properties are improved, and this results in a better driving sensation.

According to a first aspect of the invention, a spring for a brake pad assembly of a braking device, in particular a disk brake is proposed, the spring being designed to be pushed onto an interlocking element of a brake pad carrier plate, and the spring comprising a clamp for securing the spring to the interlocking element and a support member for supporting and sliding on a brake caliper, wherein:
the support member of the spring has a first leg which is designed to face toward the brake caliper and which has a curved, concave shape, such that when the brake pad carrier plate and the spring are installed inside the brake caliper, the first leg forms a connecting section between a second leg and a third leg, which are designed to come into contact with the brake caliper in a supporting and sliding manner;
the clamp of the spring has a fourth leg, a fifth leg, and a sixth leg, which are designed and arranged in such manner that when the brake pad carrier plate and the spring are installed inside the brake caliper they face toward the brake pad carrier plate; and
the spring also has a connecting leg which connects the clamp integrally to the support member of the spring.

The spring should in particular be understood to be a bracket or a clip of a brake pad assembly. These terms should be understood as synonymous. The spring serves to separate the brake pad carrier plate of the brake pad assembly from the brake caliper and to reduce the tendency to produce braking noises and vibrations. Consequently, the spring is provided in order to decouple the two metallic components from one another, i.e., on the one hand the brake pad carrier plate and on the other hand the brake caliper, in particular when they are fitted in the brake caliper along the radial direction of the rotation axis of the brake disk. Direct contact between the brake pad carrier plate and the brake caliper is thereby prevented.

The spring has a plurality of legs connected integrally with one another, such that in the longitudinal extension of the spring, essentially flat and essentially bent or curved legs are arranged in alternation one after another. Each curved leg is preferably followed by a flat leg, and vice versa. The legs of the spring are connected integrally with one another and form the spring. The legs of the spring are designed in such manner that the spring forms essentially an S-shape. The spring comprises on the one hand legs that are shaped and arranged so that they are in contact with the interlocking element of the brake pad carrier plate. These are the legs of the clamp of the spring. In addition, the spring has legs which are shaped and arranged in such manner that they are in contact with the brake caliper. These are the legs of the support member of the spring.

The spring is formed by the clamp that secures the spring, in the assembled state of the brake pad assembly, onto the brake pad carrier plate, the support member which in the assembled state of the brake pad assembly supports the brake pad assembly on the brake caliper, and the connecting leg which can connect one or more legs joined to one another and the clamp integrally to the support member. In other words, the connecting leg can be formed of a plurality of flat and/or curved legs.

The interlocking element of the brake pad carrier plate is an eyelet or a projection on the brake pad carrier plate which stands out in the circumferential direction of a rotating component, in particular the brake disk. The spring is attached, in particular clamped to this interlocking element, in order to separate the brake pad carrier plate from the brake caliper. Thus, the interlocking element is a lateral projection from the brake pad carrier plate.

The second and third legs of the spring, which are connected to one another by the first leg, serve as contacting sections for supporting and sliding the spring on the brake caliper. Owing to its concavely curved shape, in the assembled state of the brake pad assembly the first leg on the support member does not come into contact with the brake caliper. To put it differently, the first leg is curved in such manner that in the assembled state of the brake pad assembly a gap exists between the first leg and the brake caliper. The support member is supported on the brake caliper only by the second and third legs. This design of the support member is advantageous for ensuring that contact with the surface of the brake caliper only takes place in two different areas which, by virtue of the length of the curved first leg, are separated and a distance apart from one another. Since there are two points of contact instead of only one, better support of the spring on the brake pad carrier plate and conversely can be realized.

Preferably, the spring is made of metal, in particular a stainless laminated flat strip. The spring is preferably made of stainless steel. In that way, the spring can be produced simply and inexpensively. The spring is advantageously made by rolling, stamping, and deforming. In an example embodiment, the spring has an essentially rectangular cross-section. Preferably, the thickness of the spring is between 0.5 mm and 1.0 mm, in particular between 0.6 mm and 0.8 mm. Preferably, the width of the spring is between 2 mm and 5 mm, in particular between 2.5 mm and 4.0 mm. Preferably, the width and/or the thickness of the spring along a longitudinal extension, i.e., along a notionally unwound spring, are essentially constant. In that sense, the spring is free from holes, projections and/or grooves on its surface.

Preferably, the spring is designed such that in the assembled state it is connected with interlock to the brake pad carrier plate. In other words, the width of the spring is chosen such that an interlock is formed with the brake pad carrier plate. For that purpose, the brake pad carrier plate can have, for example, a groove which, in the assembled state of the brake pad assembly, is designed to receive the spring with interlock, in particular individual or all of the legs of the clamp of the spring. In that sense, the width of the spring is chosen such that it forms an effective interlocking connection with the groove width of the interlocking element or the lateral projection of the brake pad carrier plate.

The invention embodies the technical principle that the fourth leg and/or the fifth leg of the clamp is/are designed in such manner that it/they come into flat contact with the interlocking element of the brake pad carrier plate. In that way, a uniform force transmission between the spring and the brake pad carrier plate can take place without stress peaks. Consequently, the spring is thereby better supported on the brake pad carrier plate and conversely.

Preferably, in the assembled state of the spring, a surface of the fourth leg facing toward the brake pad carrier plate and a surface of the fifth leg facing toward the brake pad carrier plate are arranged at an angle of 90° relative to one another. This is advantageous in order to ensure that, in the assembled state of the brake pad assembly, there is a secure connection in the braking device between the brake pad carrier plate and the clamp.

Preferably, an opening distance between the fourth leg and the sixth leg is smaller than a thickness of the brake pad carrier plate. This ensures that due to elastic deformation of the legs of the clamp that the spring is connected firmly to the brake pad carrier plate when the spring is mounted on the brake pad carrier plate. In a preferred embodiment, the opening distance is 0.5 to 1.5 mm smaller than the thickness of the brake pad carrier plate.

In an example embodiment, on a side of the third leg opposite the first leg a seventh leg is arranged, the longitudinal extension of which is shorter than the fourth leg. This ensures that in the assembled state of the brake pad assembly there is no contact between the seventh leg and the fifth leg or any other leg of the clamp.

According to a second aspect of the invention, a brake pad assembly for a braking device is proposed, which comprises at least one spring according to the first aspect of the invention, wherein the spring is arranged on a brake pad carrier plate. Besides the spring, the brake pad assembly comprises one or more brake pad carrier plates on each of which a respective brake pad is arranged. Preferably, each brake pad carrier plate is held by two springs onto the brake caliper. The brake caliper can be a brake caliper housing or part of a brake caliper housing.

Preferably, the brake pad carrier plate has a groove which is designed to hold a leg of the clamp with interlock in such manner that movement of the brake pad carrier plate relative to the spring and conversely in the circumferential direction of a brake disk of the braking device is prevented. Preferably, the groove holds the fourth leg of the spring at least partially in order to produce the interlock.

According to a third aspect of the invention, a braking device is proposed, which comprises a brake pad assembly according to the second aspect of the invention. The braking device is preferably in the form of a disk brake. The braking device comprises the brake caliper in which, in the installed state, the brake pad assembly and a brake disk are arranged, wherein when the braking device is correspondingly actuated the brake disk can be brought into frictional contact with the brake pads of the brake pad assembly. The braking device or disk brake preferably comprises two brake blocks, each formed by a brake pad carrier plate with a brake pad arranged on it, a brake disk and a brake caliper. The two brake pads are arranged on the brake caliper, which covers the brake disk on both sides transversely to the direction of travel, i.e., on the inside and on the outside.

The above definitions and remarks about technical effects, advantages, and advantageous embodiments of the spring according to the first aspect of the invention also apply to the brake pad assembly according to the second aspect of the invention and to the braking device according to the third aspect of the invention, and vice versa. It is understood that features of the systems described above or in the claims and/or the figures can also be combined, if necessary, in order to be able to produce, cumulatively, the advantages and effects that can be achieved herewith.

### BRIEF DESCRIPTION OF THE DRAWINGS

Below, a preferred embodiment of the invention is described in greater detail with reference to the figures, in which the same or similar elements are denoted by the same indexes and which show:

FIG. 1: A schematic sectioned representation of a braking device according to the invention in the form of a disk brake,

FIG. 2: A schematic perspective representation of a brake block of an only partially shown brake pad assembly according to the invention of the braking device of FIG. 1,

FIG. 3: A first detailed perspective representation of the brake block according to FIG. 2,

FIG. 4: A second detailed perspective representation of the brake block according to FIGS. 2 and 3,

FIG. 5: A third detailed perspective representation of the brake block according to FIGS. 2 to 4,

FIG. 6: A very schematic sectioned representation of the partially shown braking device of FIG. 1 in an installed state of the brake pad assembly according to FIGS. 2 to 5,

FIG. 7: A schematic perspective representation of a spring according to the invention, of the brake pad assembly according to FIGS. 1 to 6, before installation, and

FIG. 8: A schematic view of the spring according to the invention, of the brake pad assembly before installation, according to the present disclosure.

### DETAILED DESCRIPTION

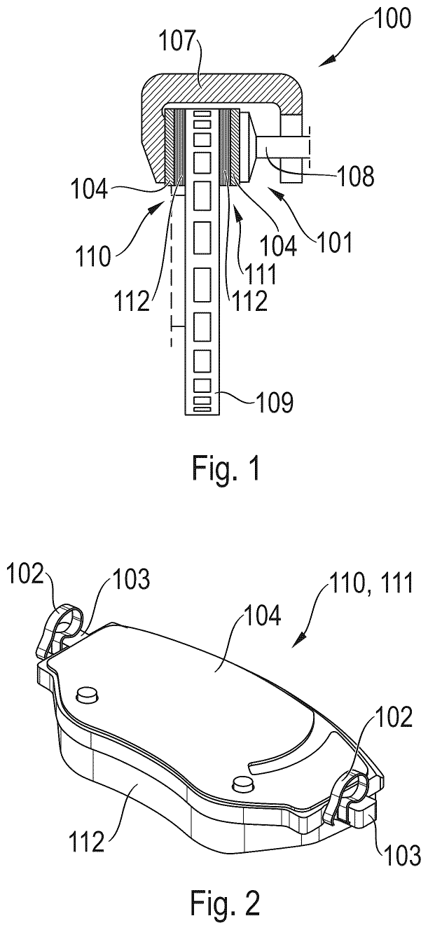

According to FIG. 1 a braking device 100 according to the invention is shown in the form of a disk brake which can be actuated mechanically. The disk brake 100 comprises a brake caliper 107 which, in a manner known as such, has a U-shaped cross-section. On the right-hand leg in FIG. 1, the brake caliper 107 has an actuating push-rod 108 that can be displaced by mechanical actuation and is guided in a cylinder (not shown here). The actuating push-rod 108 can be moved in a direction toward a brake disk 109 or away from it, so that an outer brake block 110 and an inner brake block 111 can be pressed against the brake disk 109 or retracted from it. The cylinder acts as a reaction element which, when the disk brake 100 is actuated mechanically, acts upon the reaction surface of the brake caliper 107 facing it in such manner that both the outer brake pad and the inner brake pad of the corresponding brake blocks 110, 111 can be pressed on essentially at the same time.

Each brake block 110, 111 is formed of a respective brake pad carrier plate 104 and an associated brake pad 112, wherein the respective brake pad 112 is located spatially between the brake disk 109 and the respective brake pad carrier plate 104. The brake disk 109 is located between the two brake pads 112. The brake blocks 110, 111 are part of a brake pad assembly 101 according to the invention.

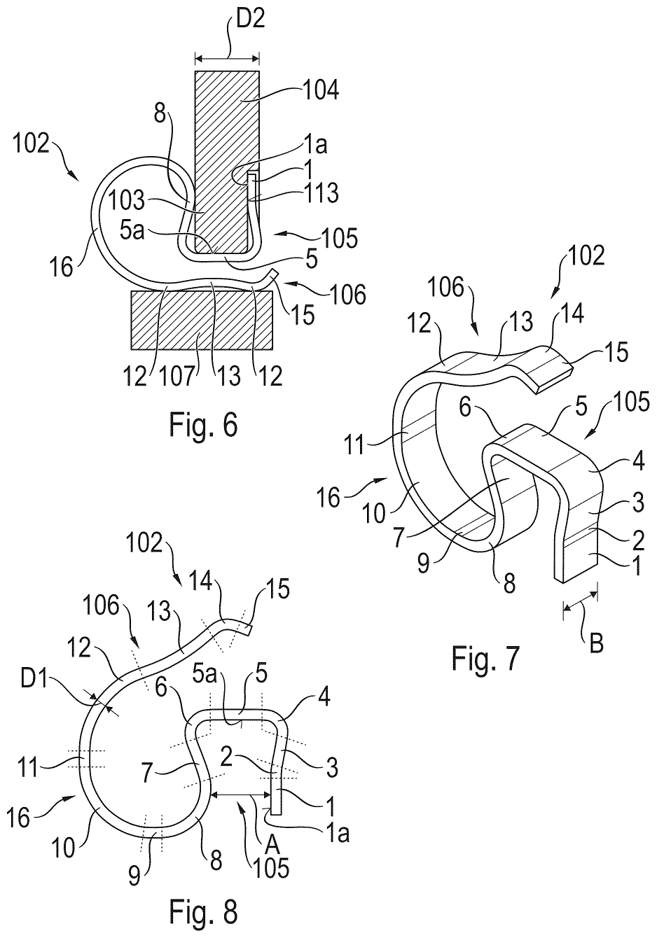

On sides of the brake disk 109 opposite the brake pad carrier plate 104 of the brake block 110, 111 concerned in the circumferential direction, according to FIGS. 2 to 5 in combination with FIG. 1 and FIG. 6 interlocking elements 103 are formed, which are connected integrally with the rest of the brake pad carrier plate 104 of the respective brake block 110, 111. The respective interlocking element 103 is a lateral projection of the brake pad carrier plate 104. On the interlocking elements 103, in each case, a spring 102 according to the invention is arranged in an effective manner. The spring 102 in each case is designed to be pushed onto the associated interlocking element 103 of the brake pad carrier plate 104, wherein the spring 102 concerned is designed and arranged in such manner that the brake pad carrier plate 104 is supported and slides on the brake caliper 107 as shown in FIG. 6. Thus, the respective brake pad carrier plate 104 is decoupled from the brake caliper 107 by the two springs 102 fixed to it, whereby the tendency to produce braking noises and vibrations when the braking device 100 is actuated, is reduced. In what follows, one of the interlocking elements 103 of the brake pad carrier plate 104 will be considered and illustrated as an example, whereas the other interlocking element 103 of the same brake pad carrier plate 104 is made as a mirror-image thereof.

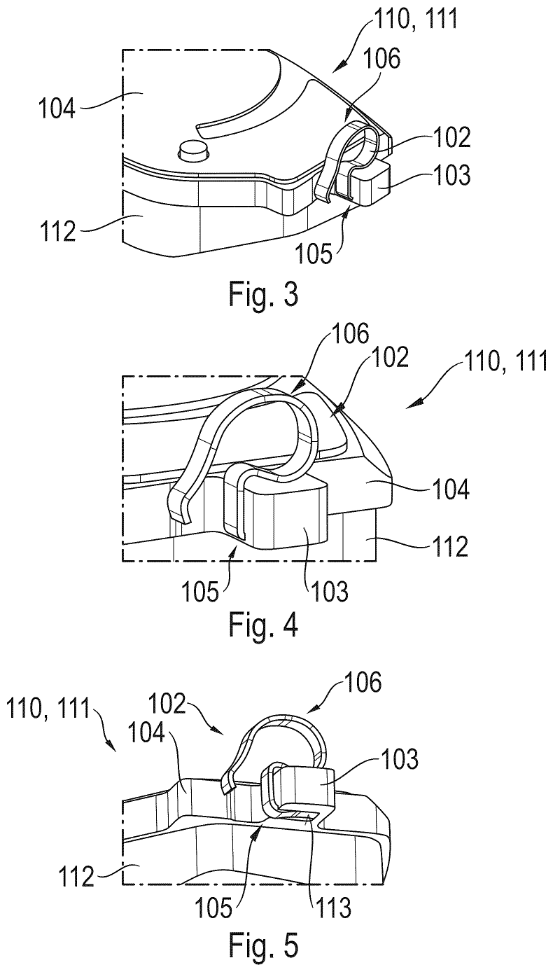

According to FIGS. 7 and 8, in combination with FIG. 3 to FIG. 6, the spring 102 comprises a clamp 105 designed to fix the spring 102 onto the interlocking element 103, and a support member 106 which is designed to support and slide on the brake caliper 107. In the present case the spring 102 consists of fifteen legs, some of them being flat, i.e., with no curvature, and some being curved, and which are connected integrally with one another in such manner that the spring 102 is essentially S-shaped. The spring 102 is formed from a stainless, laminated, flat strip, in this case stainless steel, and has a rectangular cross-section profile. Over its entire length the spring 102 has a constant thickness DI of between 0.6 mm and 0.8 mm, and a constant width B of between 2.5 mm and 4.0 mm. Furthermore, the spring 102 is free from holes, projections and/or grooves on its surface.

In the assembled state of the brake pad assembly 101, the support member 106 of the spring 102 is arranged facing toward the brake caliper 107. The spring 102 has a first leg 13, a second leg 12, and a third leg 14, such that the first leg is concavely curved and connects the second and third legs 12, 14 integrally to one another. In particular, from FIG. 6 it can be seen that when the brake pad carrier plate 104 and the spring 102 are fitted on or in the brake caliper 107, then owing to its curved shape the first leg 13 does not come into contact with the brake caliper 107, whereas the second and third legs 12, 14 serve as contact areas between the spring 102 and the brake caliper 107 and are accordingly in contact with the brake caliper 107. The legs 12 and 14 are designed and shaped in such manner that the spring 102 can slide on the surface of the brake caliper 107. Thus, the first leg 13 should be understood to be a connection section for the second and third legs 12, 14. On a side of the third leg 14 opposite the first leg 13, a seventh leg 15 is arranged which is shorter than the fourth leg 1. Thus, the support member 106 is prevented from coming into contact with the clamp 105.

In the assembled state of the brake pad assembly 101, the clamp 105 of the spring 102 is arranged facing toward the interlocking element 103 of the brake pad carrier plate 104. The clamp 105 comprises a fourth leg 1, a fifth leg 5, and a sixth leg 8, wherein the legs 1, 5 and 8 are designed and shaped so that they surround the interlocking element 103 and thereby fix the spring 102 onto the brake pad carrier plate 104. Consequently, when the brake pad carrier plate 104 and the spring 102 are fitted on or in the brake caliper 107, the legs 1, 5 and 8 are in contact with the brake pad carrier plate 104.

In the installed state, the spring 102 is also connected with interlock to the brake pad carrier plate 104. For that purpose, the brake pad carrier plate 104 has a groove 113 which is designed to receive a leg of the clamp 105 with interlock. In the present case, the groove 113 is arranged in such manner that the fourth leg 1 of the spring 102 is introduced into the groove 113 and prevents any relative movement between the spring 102 and the brake pad carrier plate 104 in the circumferential direction of the brake disk 109, and vice versa.

The fourth leg 1 and the fifth leg 5 are designed such that they make flat contact against the interlocking element 103 of the brake pad carrier plate 104. In the installed state of the spring 102, a surface la of the fourth leg 1 facing toward the brake pad carrier plate 104 and a surface 5a of the fifth leg 5 facing toward the brake pad carrier plate 104 are arranged at an angle of 90° relative to one another. Furthermore, an opening distance A between the fourth leg 1 and the sixth leg 8 is smaller than a thickness D2 of the brake pad carrier plate 104, so that when the spring 102 is clamped onto the brake pad carrier plate 104 a bracing effect is produced and the spring 102 is held securely on the interlocking element 103 of the brake pad carrier plate 104.

The clamp 105 and the support member 106 are connected integrally to one another by a connecting leg 16, the connecting leg being formed of an eighth leg 9, a ninth leg 10, and a tenth leg 11.

Between the fourth leg 1 and the fifth leg 5, an eleventh leg 2, a twelfth leg 3, and a thirteenth leg 4 are arranged, which are shaped in such manner that they do not make contact with the interlocking element 103 of the brake pad carrier plate 104.

Between the fifth leg 5 and the sixth leg 8, a fourteenth leg 6 and a fifteenth leg 7 are arranged, which are shaped in such manner that they do not make contact with the interlocking element 103 of the brake pad carrier plate 104.

If the spring 102 is notionally unwound, then the fourth leg 1 is followed integrally by the eleventh leg 2, adjacent thereto is the thirteenth leg 4, adjacent thereto is the fifth leg 5, adjacent thereto is the fifteenth leg 7, adjacent thereto is the sixth leg 8, adjacent thereto is the eighth leg 9, adjacent thereto is the ninth leg 10, adjacent thereto is the tenth leg 11, adjacent thereto is the second leg 12, adjacent thereto is the first leg 13, adjacent thereto is the third leg 14, and adjacent thereto is the seventh leg 15.

The legs 1, 3, 5, 7, 9, 11 and 15 are essentially flat, whereas the legs 2, 4, 6, 8, 10, 12, 13 and 14 are of essentially curved shape.

### Indexes

1 Fourth leg of the spring
1a Surface of the fourth leg
2 Eleventh leg of the spring
3 Twelfth leg of the spring
4 Thirteenth leg of the spring
5 Fifth leg of the spring
5a Surface of the fifth leg
6 Fourteenth leg of the spring
7 Fifteenth leg of the spring
8 Sixth leg of the spring
9 Eighth leg of the spring
10 Ninth leg of the spring
11 Tenth leg of the spring
12 Second leg of the spring
13 First leg of the spring
14 Third leg of the spring
15 Seventh leg of the spring
16 Connecting leg
100 Braking device or disk brake
101 Brake pad assembly
102 Spring
103 Interlocking element of the brake pad carrier plate
104 Brake pad carrier plate
105 Clamp of the spring
106 Support member of the spring
107 Brake caliper
108 Actuating push-rod
109 Brake disk
110 Outer brake block
111 Inner brake block
112 Brake pad
A Opening distance
B Width of the spring
D1 Thickness of the spring
D2 Thickness of the brake pad carrier plate

1-14. (canceled)

15. A spring (102) for a brake pad assembly (101) of a braking device (100), in particular a disk brake, wherein the spring (102) is configured to be pushed onto an interlocking element (103) of a brake pad carrier plate (104), the spring (102) comprising:
a support member (106) configured for supporting and sliding on a brake caliper (107), the support member having a first leg (13) configured to face toward the brake caliper (107) and having a concave curved shape;
a second leg (12) on one side of the first leg (13);
a third leg (14) on an opposite second side of the first leg (13);
a clamp (105) configured for securing the spring (102) onto the interlocking element (103), the clamp (105) having a fourth leg (1), a fifth leg (5), and a sixth leg (8) each configured and arranged in such manner that when the brake pad carrier plate (104) and the spring (102) are installed inside the brake caliper (107), the fourth leg, the fifth leg, and the sixth leg each faces toward the brake pad carrier plate (104); and
a connecting section (16) integrally connecting the clamp (105) to the support member (106);
wherein when the brake pad carrier plate (104) and the spring (102) are installed inside the brake caliper (107), the first leg (13) forms a connecting section between the second leg (12) and the third leg (14), wherein each of the second leg and the third leg is configured to contact the brake caliper (107) in a supporting and sliding manner.

16. The spring (102) according to claim 15, wherein the spring (102) is made of metal.

17. The spring (102) according to claim 16, wherein the spring (102) is made from a stainless, laminated flat strip.

18. The spring (102) according to claim 15, wherein at least one of the fourth leg (1) and the fifth leg (5) is configured to come into flat contact against the interlocking element (103) of the brake pad carrier plate (104).

19. The spring (102) according to claim 18, wherein in the installed state, a surface (1a) of the fourth leg (1) facing toward the brake pad carrier plate (104) and a surface (5a) of the fifth leg (5) facing toward the brake pad carrier plate (104) are arranged at an angle of 90° relative to one another.

20. The spring (102) according to claim 15, wherein the spring has a thickness (D1) from 0.5 mm to 1.0 mm.

21. The spring (102) according to claim 20, wherein the spring has a width (B) from 2 mm to 5 mm.

22. The spring (102) according to claim 15, wherein in the installed state the spring is connected to the brake pad carrier plate (104) with interlock.

23. The spring (102) according to claim 15, wherein a surface of the spring (102) is free from holes, projections, and/or grooves.

24. The spring (102) according to claim 15, wherein an opening distance (A) between the fourth leg (1) and the sixth leg (8) is smaller than a thickness (D2) of the brake pad carrier plate (104).

25. The spring (102) according to claim 15, further comprising a seventh leg (15) on a side of the third leg (14) opposite the first leg (13), wherein a longitudinal extension of the seventh leg is shorter than the fourth leg (1).

26. A brake pad assembly (101) for a braking device (100), comprising:
at least one spring (102) according to claim 15; and
a brake pad carrier plate (104);
wherein the spring is arranged on a brake pad carrier plate (104).

27. The brake pad assembly (101) according to claim 26, wherein the brake pad carrier plate (104) defines a groove (113) configured to hold a leg (1) of the clamp (105) with interlock in such manner that a movement of the brake pad carrier plate (104) relative to the spring (102) and vice versa, in the circumferential direction of a brake disk (109) of the braking device (100), is prevented.

28. A disk brake comprising a brake pad assembly having at least one spring (102) according to claim 15 and a brake pad carrier plate (104), wherein the spring is arranged on a brake pad carrier plate (104).

29. The disk brake according to claim 28, wherein the brake pad carrier plate (104) defines a groove (113) configured to hold a leg (1) of the clamp (105) with interlock in such manner that a movement of the brake pad carrier plate (104) relative to the spring (102) and vice versa, in the circumferential direction of a brake disk (109) of the braking device (100), is prevented.
